(19) United States
(12) Patent Application Publication
(10) Pub. No.: US 2009/0063336 A1
(43) Pub. Date: Mar. 5, 2009

(54) Financial & technology solutions for 21st century crime fighting

(76) Inventors: James D. Slinker, Aubrey, TX (US); Russell S. Henry, Gladstone, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/045,637

(22) Filed: Mar. 10, 2008

Related U.S. Application Data
(60) Provisional application No. 60/894,111, filed on Mar. 9, 2007.

(51) Int. Cl. G06Q 40/00

(52) U.S. Cl. 705/39; 705/35

(57) ABSTRACT

A self-funded resource collection process that collects recourses, such as identification and crime fighting technology, that are required by an agency, such as a law enforcement agency, and provides means for funding the self-funded resource collection process.

### CROSS-REFERENCE TO RELATED APPLICATIONS

This application claims priority of U.S. Provisional Patent Application No. 60/894,111, filed Mar. 9, 2007, in the United States Patent and Trademark Office, the disclosure of which is incorporated herein by reference in its entirety.

### BACKGROUND OF THE INVENTION

1. Field of the Invention

The present general inventive concept relates generally to a self-funding resource collection process, and more particularly, to a process that collects recourses, such as identification and crime fighting technology, that are required by an agency, such as a law enforcement agency, and provides means for funding the process.

2. Description of the Related Art

The most powerful shift in the public business environment is the ever-increasing pressure on government/agencies to reduce costs. When or as business conditions turn down, budgetary direction(s) change due to events/actions, and/or grant dollars run out; the order goes out to all agencies to cut expenses, including those badly needed purchases. In order to cut overall supplier, product, and service costs, agencies need to understand what they're utilizing and buying.

The goal of all pretrial services agencies is to maximize rates of defendant release while minimizing rates of defendant fail to appear (FTA) and re-arrest of defendant while awaiting adjudication of current charge(s). Additionally, they are utilized so that the only persons who are detained are those in which no condition or combination of conditions can reasonably assure the defendants' appearance in court and maintain community safety. These goals have made pretrial services an appealing mechanism in efforts to lessen jail crowding. As a result, many jurisdictions have looked to pretrial services programs to play a key role in reducing jail populations.

The challenge for pretrial services born of a concern for jail crowding is to provide information needed to assess and manage risks to those delegated with the responsibility of making release decisions. A pretrial services agency reaches these goals by providing timely, verified information to hail decision-makers along with options for the safe release of defendants, which in turn should work to reduce unnecessary pretrial detention.

As a result of the efforts of many pretrial services programs, courts and legislatures have recognized the intrinsically discriminatory effects of the money bail system and have sought to restructure them through extensive use of release on recognizance (ROR) and supervised release programs. Today pretrial services have become an institutionalized part of the criminal case disposition process, especially in larger jurisdictions.

No others within the criminal justice system have more control over the ebb and flow of jail populations than judges. Judges are involved, directly and indirectly, in all aspects of criminal case processing. Judges on each type of court affect jail admissions and length of confinement (LOC). In addition, judges in leadership positions, working with others in the criminal justice system, can accomplish much to alleviate jail crowding.

The courts' pivotal position in the criminal justice system places judges, particularly presiding or administrative judges, in a leadership position to formulate and implement a system-wide approach to alleviating or preventing jail crowding. Judicial leadership is needed to achieve effective efforts to alleviate jail crowding. Judges affect jail population through their decisions in individual cases, their authority to set court rules for processing cases, and their leadership position in the criminal justice system. As leaders, judges can call together their brethren and others to examine the entire criminal justice system and its impact on jail population. They must take advantage of and support for safe, money-saving innovations.

Most state statutes or court rules specify the types of conditions that judicial officers can set. These include requiring the defendant to remain at or away from a certain address, area, or person; report regularly to a court agency; and refrain from using illegal drugs. In many jurisdictions, pretrial programs monitor court-ordered release conditions. All provide the judge with ultimate authority to administer pretrial release programs as well as place any condition upon bond (regardless of type) they deem appropriate.

According to national jail inmate statistics, the majority of pretrial inmates are those who cannot post a money bond. The court creates procedures and rules that determine when, where, and how release decisions are made and establishes hail schedules that allow defendants to post a money bond prior to appearing before a judicial officer.

All of these programs require significant equipment and resources to ensure the agency in charge of the pretrial release program have all the information necessary to administer the program. Such information may include background information on a person being incarcerated and potentially up for release. Traditionally, such resources come at great expense to the agency or ultimately to the tax payers. Therefore, it would be beneficial to provide a method for funding such resources at a lower cost to the agency and/or taxpayers.

### SUMMARY OF THE INVENTION

The present general inventive concept provides a self-funded resource collection process that collects recourses, such as identification and crime fighting technology, that are required by an agency, such as a law enforcement agency, and provides means for funding the self-funded resource collection process.

The foregoing and/or other aspects of the present general inventive concept may be achieved by providing a method of funding agency equipment at an agency, the method including determining an agency's equipment desires, matching the agency's equipment desires with one or more third-party equipment vendors, obtaining equipment provided by the one or more third-party equipment vendors at no cost to the agency, installing equipment provided by the one or more third-party equipment vendors at the agency, charging a fee to a person arrested and processed utilizing the equipment, and submitting the fee to the third-party provider to pay for the cost of the equipment.

The one or more third-party equipment may collect personal information and be an automated fingerprint identification system, automated palm identification system, facial recognition equipment, retina recognition equipment, fingerprinting equipment, and/or photograph equipment.

The one or more third-party equipment may be equipment and/or a service.

The service may be training to use an automated fingerprint identification system, automated palm identification system, facial recognition equipment, retina recognition equipment, fingerprinting equipment, or photograph equipment.

The method may further include providing a means to receive payment for the equipment at the agency.

The means to receive payment may be a credit card machine located at the agency.

The means to receive the fee may be provided to the agency by the third-party provider and the portion of the fee may be submitted directly to the third-party provider from the person.

The third party provider may be independent from the third-party equipment vendors.

The fee may be collected by the agency and then at least a portion of the fee may be submitted to the third-party equipment vendors.

The funds may be submitted to a finance group separate from the third-party equipment vendors.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims. A more complete appreciation of the invention and many of the advantages thereof will be readily obtained as the same becomes better understood by references to the detailed description when considered in connection with the accompanying drawings, wherein:

FIG. 1 is a schematic of an exemplary embodiment of the present general inventive concept illustrating the system linking one or more vendors to an agency.

### DETAILED DESCRIPTION OF THE INVENTION

The present general inventive concept is a process that aligns the objectives and strategies of Criminal Justice agencies (“the user”) by providing the tools necessary to obtain resources such as the equipment and/or services necessary to achieve their goals at no cost to the government or the taxpayer.

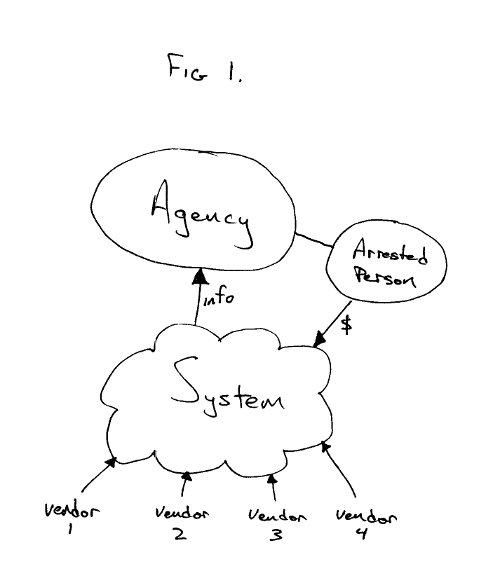

The present general inventive concept, as illustrated in FIG. 1, provides funding for the acquisition of user equipment at the user. After determining the user's equipment desires, the present general inventive concept matches the user with one or more third-party equipment vendors that will satisfy the desires and that equipment is installed by the one or more third-party equipment vendors at the agency. The cost of the equipment is provided without charging the agency. Instead, the cost of the equipment is covered over the course of time by charging fees to people incarcerated by the agency and/or processed by the agency utilizing the equipment. The user is authorized to charge such a fee via existing statutes. The user is provided with means to collect and receive the fee via computer interface, a credit card machine, and/or the like.

At least a portion of the fees collected are then preferably submitted directly from the person to a centralizer to distribute at least a portion of the fees to the third-party provider to pay for at least a portion of the cost of the equipment. It is foreseen that a portion of the fees collected may also be submitted to a finance group separate from the third-party equipment vendors, such as a bank that assists with loans for the equipment.

The equipment may collect personal information and may be an automated fingerprint identification system, automated palm identification system, facial recognition equipment, retina recognition equipment, fingerprinting equipment, and/or photograph equipment. The equipment may also be a service such as training to use the automated fingerprint identification system, automated palm identification system, facial recognition equipment, retina recognition equipment, fingerprinting equipment, and/or photograph equipment.

The present general inventive concept adjusts to the user's criminal justice strategies by allowing the user to select one or all of the equipment and/or services available. Thus, the present general inventive concept provides for enhancement, support, and flexibility within the agency.

The present general inventive concept does not replace any existing programs or information sharing systems currently in service. Rather, the present general inventive concept is added to the user's current systems and programs. The present general inventive concept provides enhancement of offender information based on “identification” instead of relying exclusively on verification methods. The present general inventive concept provides FBI and/or State certified “live scan” system(s), “regional” automated fingerprinting identification systems (AFIS), automated palm identification system (APIS), services and/or training programs (providing “lights-out” criminal fingerprint submission and processing), offender identification ability, and interoperable communications with 256 AES encryption (appliance and software).

Other technology and/or services available via the present general inventive concept include NIST pack 5, software modules to assist law enforcement in their investigations and identification process, software modules to assist agencies with their HR requirements, local or regional AFIS systems, satellite technology which would provide departments with seamless voice transmissions, installation of all system components by highly qualified technicians, system training by certified training personnel, and/or training in other areas of forensics, and investigative techniques.

The present general inventive concept is ideal for use at the metropolitan and/or micropolitan level and may also be used within County Sheriff Departments as well as municipal law enforcement agencies. Additionally, the present general inventive concept will provide “true” interoperable communications capability in the event of a manmade or natural disaster.

The present general inventive concept provides equipment from vendors for the collection of detailed personal information. Such detailed information includes fingerprints and mug shots, which are first collected from an offender during booking (the “intake process”) by an agency in most cases.

Basic system components, hardware, and software may be provided to each agency which meet both state and federal requirements for both the electronic submission and manual submission of data to any state agency.

The present general inventive process provides the user with one point of contact regardless of the number of vendors for services and/or equipment the user uses. A scope of work is prepared at a user site and presented to the user and other parties by a single third-party provider.

Fees may be collected at the point of booking and/or arrest of a person. Most fees will be collected electronically and transferred along the appropriate channels. One example of a fee collection includes where a fee is collected by the user. The fee may be paid by credit card, check, and/or cash. The fee processing equipment may be provided via the present general inventive concept.

The present general invention assists with pretrial release decisions. When deciding pretrial release, the judicial officer should assign the least restrictive condition(s) of release that will reasonably ensure a defendant's attendance at court proceedings and protect the community, victims, witnesses or any other person. Such conditions may include participation in drug treatment, diversion programs or other pre-adjudication alternatives. The court should have a wide array of programs or options available to promote pretrial release on conditions that ensure appearance and protect the safety of the community, victims and witnesses pending trial and should have the capacity to develop release options appropriate to the risks and special needs posed by defendants, if released to the community. When no conditions of release are sufficient to accomplish the aims of pretrial release, defendants may be detained through specific procedures.

Pretrial programs may be used in court, jail, and probation departments; they may also be used by independent or private agencies. Pretrial services programs can help alleviate jail crowding by providing three essential services. First, they provide information about the defendant to help the decision-maker make an appropriate pretrial release/detention decision. Second, they provide the decision-maker options for safely releasing the defendant. Third, they have the capacity to monitor and supervise defendants released before trial

There are several advantages of using an objective risk assessment tool. An objective instrument ensures consistency of application from one interviewer to another. It also ensures that the release/detention decision is made in an equitable fashion. Since the risk criteria are spelled out, it is also more visible. Finally, by isolating the factors considered in the release/detention decision, the data exist to provide on-going refinement of the instrument as more information becomes available and circumstances change.

The criminal justice process begins when a crime is reported to the police, or in some instances the police may discover the crime through informants, proactive investigation, or other means. The police will follow up with an investigation, determining the legitimacy of the allegations, and establish that a crime has been committed. The next step is to identify a suspect, who may then be arrested and taken to the police station where they undergo hooking. The booking process establishes an administrative record for the suspect. At this stage of the process, the suspect is placed in custody and is subjected to a number of personal information gathering processes, such as, but not limited to automated fingerprint identification system (AFIS), automated palm identification system (APIS), facial recognition equipment, retina recognition equipment, fingerprinting equipment, or photograph equipment.

The present general inventive concept allows these processes to be bundled together or unbundled and broken down into their components. This allows users to pick and choose which of these elements they prefer to do themselves, if they have the resources and expertise available. They can then allocate the other elements to different service providers, based on which one can do the best job at the lowest price. The present general inventive concept allows integration of these different elements into a single business process that results in the desired outcome.

The present general inventive concept provides a single provider thereby that brings the advantages of superior cost, specialization, and industry-wide systems.

The present general inventive concept provides both equipment and/or services. Such services may include training of staff to use the equipment. In order to complete the core functions of any pretrial release program requires a well-trained staff. Currently, only 25% provide on-the-job training, while just 43% provide a structured training program for new staff.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims. It is also to be understood that the following claims are intended to cover all of the generic and specific features of the invention herein described, and all statements of the scope of the invention which, as a matter of language, might be said to fall there between.

What is claimed is:

1. A method of funding agency equipment at an agency, the method comprising:
determining an agency's equipment desires;
matching the agency's equipment desires with one or more third-party equipment vendors;
obtaining equipment provided by the one or more third-party equipment vendors at no cost to the agency;
installing equipment provided by the one or more third-party equipment vendors at the agency;
charging a fee to a person incarcerated by the agency and/or processed by the agency utilizing the equipment; and
submitting at least a portion of the fee to the third-party provider to pay for at least a portion of the cost of the equipment.

2. The method according to claim 1 wherein the one or more third-party equipment collects personal information and is an automated fingerprint identification system, automated palm identification system, facial recognition equipment, retina recognition equipment, fingerprinting equipment, or photograph equipment.

3. The method according to claim 1 wherein the one or more third-party equipment is a service and is training to use an automated fingerprint identification system, automated palm identification system, facial recognition equipment, retina recognition equipment, fingerprinting equipment, or photograph equipment.

4. The method according to claim 1, further comprising:
providing a means to receive the fee at the agency.

5. The method according to claim 4 wherein the means to receive the fee is a credit card machine.

6. The method according to claim 4 wherein the means to receive the fee is provided to the agency by the third-party provider and the portion of the fee is submitted directly to the third-party provider from the person.

7. The method according to claim 1 wherein the third party provider is independent from the third-party equipment vendors.

8. The method according to claim 1 wherein the fee is collected by the agency and then at least a portion of the fee is submitted to the third-party equipment vendors.

9. The method according to claim 1 wherein at least a portion of funds are submitted to a finance group separate from the third-party equipment vendors.
